(19) United States
(12) Patent Application Publication
(10) Pub. No.: US 2007/0051145 A1
(43) Pub. Date: Mar. 8, 2007

(54) Electric lock

(75) Inventor: Jing-Chen Chang, Yun-Lin Hsien (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: EZ TREND TECHNOLOGY CO.,LTD

(21) Appl. No.: 11/219,420

(22) Filed: Sep. 2, 2005

(51) Int. Cl. E05B 47/00

(52) U.S. Cl. 70/279.1

(57) ABSTRACT

An electric lock includes a lock housing unit disposed on a door, and inside and outside handle units, each of which includes a handle shaft journalled in the lock housing unit. The manual control mechanism includes a spindle coaxial with the handle shafts and having a fixed retaining portion. The spindle is rotatable so as to lock or unlock the outside handle unit. The return mechanism includes two engagement seats co-rotatable with the spring bolt unit, and a biasing unit for biasing the spring bolt unit to rotate to a locking position. When either of the inside and outside handle units is operated, the retaining portions of the handle shafts rotate the engagement seats and, thus, the spring bolt unit away from the locking position. This allows for a door opening operation to be performed.

### BACKGROUND OF THE INVENTION

1. Field of the Invention

This invention relates to an electric lock, and more particularly to an electric lock that can be locked and unlocked either electrically or manually.

2. Description of the Related Art

Referring to FIG. 1, a conventional electric lock 1 is mounted to a door 10. The door 10 has an inner side surface 101, an outer side surface 102, and a connecting surface 103 disposed between the inner and outer side surfaces 101, 102. The electric lock 1 includes a deadbolt 11 capable of projecting from the connecting surface 103, a spring bolt 12 disposed under the deadbolt 11, a lock housing 13 disposed on the inner side surface 101, inside and outside handle units 14 operable to retract the spring bolt 12 into the door 10, a bolt operating thumbturn 15 disposed on the lock housing 13 and operable to drive the deadbolt 11 to project from or retract into the connecting surface 103, a key seat 16 disposed on the outer side surface 102 and permitting insertion of a key (not shown), and an electronic control mechanism (not shown) that can be remotely controlled.

The key, a remote controller (not shown), or the bolt operating thumbturn 15 can be operated to drive the deadbolt 11 to project or retract. When it is desired to open the door 10, either of the inside and outside handle units 14 is operated to retract the spring bolt 12 into the door 10 temporarily. A disadvantage of the conventional electric lock 1 is that the spring bolt 12 is disposed under the deadbolt 11. As a result, the combined size of the spring bolt 12 and the deadbolt 11 is large.

### SUMMARY OF THE INVENTION

The object of this invention is to provide an electric lock that includes a handle shaft rotatable to move a spring bolt, and a spindle rotatable to prevent rotation of an outside handle unit, in which the handle shaft and the spindle are disposed coaxially to reduce the total volume of the electric lock.

According to this invention, an electric lock includes a lock housing unit disposed on a door, and inside and outside handle units, each of which includes a handle shaft journalled in the lock housing unit and having a fixed retaining portion. The manual control mechanism includes a spindle coaxial with the handle shafts. The spindle is rotatable so as to lock or unlock the outside handle unit. The return mechanism includes two engagement seats co-rotatable with the spring bolt unit, and a biasing unit for biasing the spring bolt unit to rotate to a locking position. When either of the inside and outside handle units is operated, the retaining portions of the handle shafts rotate the engagement seats and, thus, the spring bolt unit away from the locking position. This allows for a door opening operation to be performed.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a conventional electric lock mounted to a door;

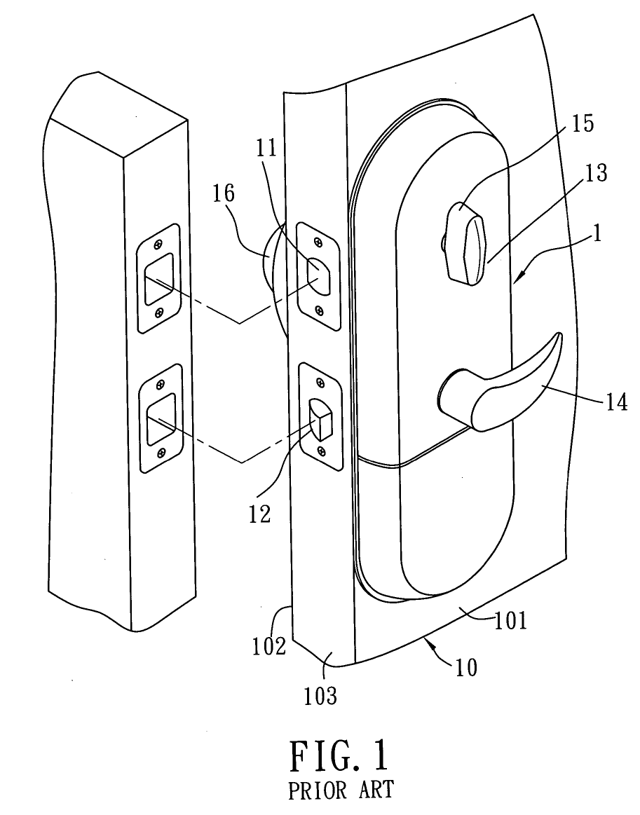

FIG. 2 is an exploded perspective view of the first preferred embodiment of an electric lock according to this invention;

FIG. 3 is a schematic sectional view of the first preferred embodiment, illustrating a locking position of a spring bolt;

FIG. 4 is a sectional view of an inside handle unit of the first preferred embodiment;

FIG. 5 is a fragmentary sectional view of the first preferred embodiment, illustrating an engagement seat of a return mechanism;

FIG. 6 is a fragmentary side view of the first preferred embodiment, illustrating how two locking plates are moved respectively into two positioning grooves in an outer lock housing so as to prevent rotation of an outside handle;

FIG. 7 is a sectional view of the inside handle unit of the first preferred embodiment, illustrating how two bridging members are moved so as to allow for relative rotation between a handle and a handle shaft;

FIG. 8 is a sectional view of the inside handle unit of the first preferred embodiment, illustrating how the positions of two direction-changing members in FIG. 4 are interchanged;

FIG. 9 is a side view of a connecting seat of the first preferred embodiment; and

FIG. 10 is a fragmentary exploded perspective view of the second preferred embodiment of an electric lock according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

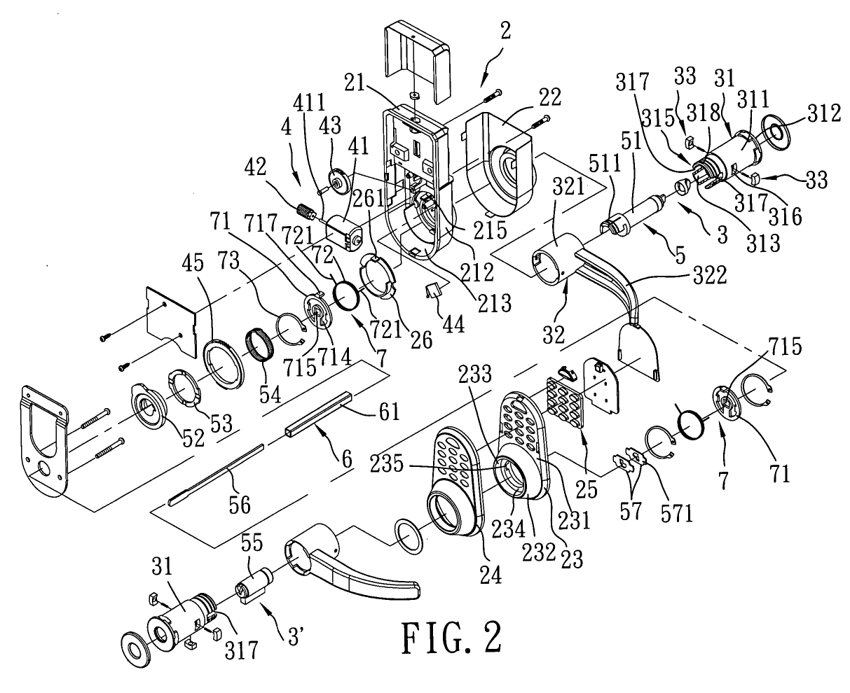

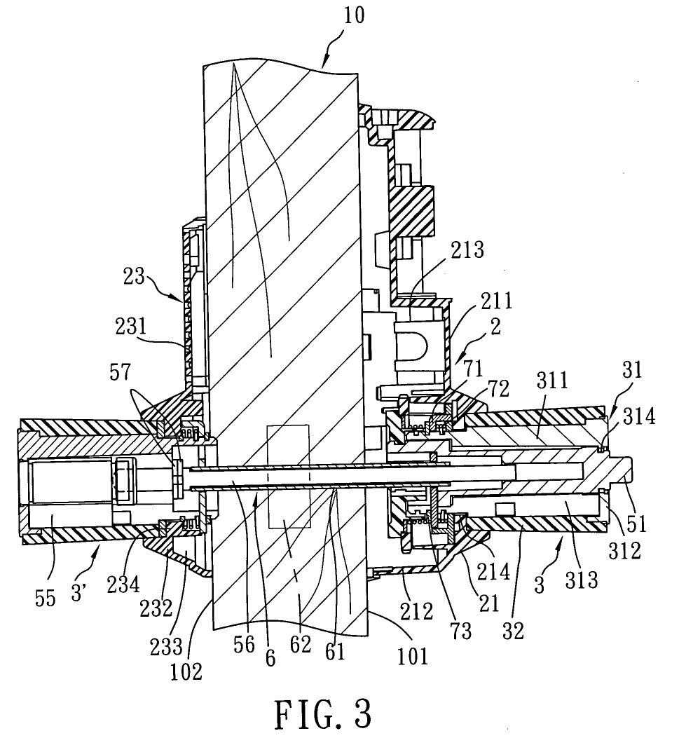

Referring to FIGS. 2 and 3, the first preferred embodiment of an electric lock according to this invention is mounted to a door 10. The door 10 has an inner side surface 101 and an outer side surface 102. The electric lock includes a lock housing unit 2, inside and outside handle units 3, 3′, a return mechanism consisting of two return units 7, an electric control mechanism 4, a manual control mechanism 5 and a spring bolt unit 6.

The lock housing unit 2 includes an inner lock housing 21, an ornamental cover 22, an outer lock housing 23, an outer ornamental cover 24 and a pushbutton unit 25. The inner lock housing 21 is disposed fixedly on the inner side surface 101, and includes an inner housing wall 211 parallel to the inner side surface 101, and a surrounding wall 212 extending from a periphery of the inner housing wall 211 to define an accommodating chamber 213 therebetween. The inner housing wall 211 is formed with a circular inner mounting hole 214 and a horizontal first abutment plate 215. The inner ornamental cover 22 is disposed fixedly on the inner lock housing 21. The outer lock housing 23 is disposed fixedly on the outer side surface 102, and includes an outer housing wall 231 parallel to the outer side surface 102, a frustoconical wall 232 extending outwardly from the outer housing wall 231 and having a diameter reducing outwardly, and an outer mounting hole 233 extending through both the frustoconical wall 232 and the outer housing wall 231. The frustoconical wall 232 has an inner wall surface that is formed with a positioning flange 234 extending radially and inwardly therefrom. The positioning flange 234 has an inner periphery that is formed with two positioning notches 235. The outer lock housing 23 further includes an integral horizontal first abutment plate (not shown) that is similar in construction to the first abutment plate 215. The outer ornamental cover 24 is disposed fixedly on the outer lock housing 23. The pushbutton unit 25 is disposed on the outer lock housing 23. The lock housing unit 2 further includes a spring positioning ring 26 disposed within the accommodating chamber 213 and formed with a horizontal plate 261 extending integrally and axially therefrom. The horizontal plate 261 is disposed under and adjacent to the first abutment plate 215 of the inner lock housing 21 so as to prevent rotation of the spring positioning ring 26 relative to the inner lock housing 21.

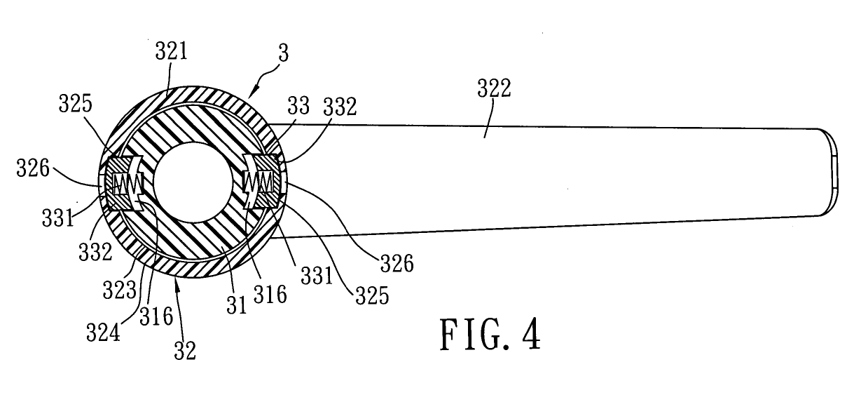

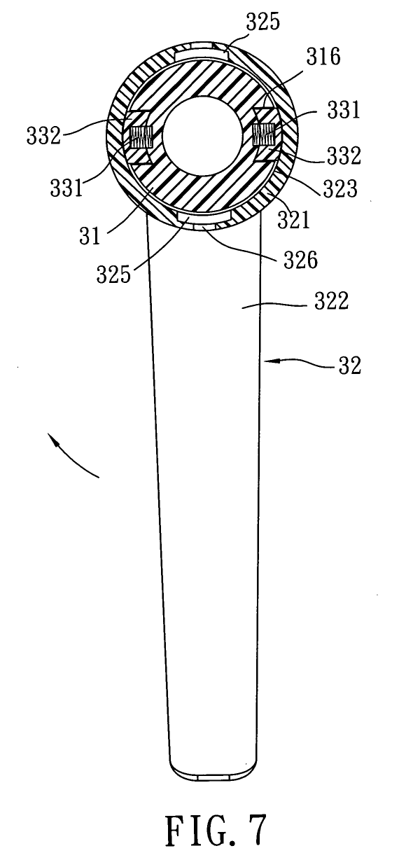

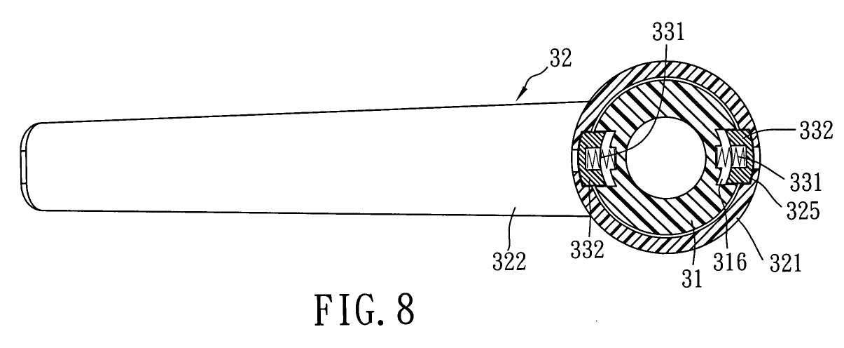

Each of the inside and outside handle units 3, 3′ includes a hollow handle shaft 31, a handle 32 and two direction-changing members 33. The handle shafts 31 are journalled respectively within the inner and outer mounting holes 214, 233 in the inner and outer lock housings 21, 23, and are similar in construction to each other. The handle shaft 31 of the inner side handle unit 3 has a shaft wall 311, an end wall 312, a central hole 313, a bearing hole 314 formed through the center of the end wall 312, an integral retaining portion 315 extending axially from the handle shaft wall 311 into the accommodating chamber 213 in the inner lock housing 21, and two diametrically opposed grooves 316 formed in an outer surface of shaft wall 311. The retaining portion 315 has an end that is formed with three open-ended axial slots 317 and a plurality of annular slot units 318. The direction-changing members 33 are disposed respectively within the grooves 316. Each of the direction-changing members 33 includes a spring 331 and a bridging member 332 biased by the spring 331 to project from the corresponding groove 316. Each of the handles 32 has a shaft portion 321 sleeved rotatably on the corresponding handle shaft 31, and a lever portion 322 extending radially from the shaft portion 321. With additional reference to FIG. 4, each of the shaft portions 321 has an inner surface 323 and an outer surface 324, two grooves 325 formed in the inner surface 323 and aligned respectively with the grooves 316 in the corresponding handle shaft 31, and two openings 326 communicated respectively with the grooves 325. Each of the bridging members 332 is biased by the corresponding spring 331 into the corresponding groove 325 so as to engage both the corresponding grooves 316, 325, thereby allowing for co-rotation of the corresponding handle shaft 31 and the corresponding handle 32. As such, a tool (not shown) can be inserted into either of the grooves 325 in the handles 32 via the corresponding opening 326 so as to push and retract the corresponding bridging member 332 into the groove 316 in the corresponding handle shaft 31, as shown in FIG. 7. This allows for rotation of the corresponding handle 32 relative to the corresponding handle shaft 31, again as shown in FIG. 7. As a consequence, the lever portion 322 of each of the handles 32 can be rotated by 180° from the position shown in FIG. 4 to that shown in FIG. 8. When the lever portion 322 of the corresponding handle 32 arrives at the position shown in FIG. 8, the bridging members 332 are biased by the springs 331 to engage the grooves 325 of the corresponding handle 32. This interchanges the positions of the corresponding direction-changing members 33 on the corresponding handle 32. Thus, the orientation of the lever portion 322 of the corresponding handle 32 can be reversed. Hence, the electric lock of this invention may be applied to the door 10 regardless of how the door 10 is mounted to a door frame (not shown).

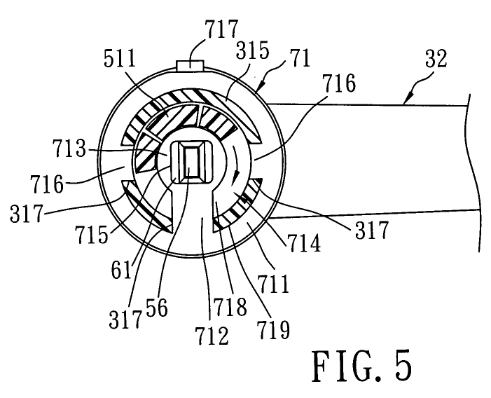

Referring to FIGS. 2, 3 and 5, the spring bolt unit 6 includes a bolt-rotating shaft 61 configured as a rectangular tube and journalled in the lock housing unit 2, and a spring bolt 62 connected fixedly to the bolt-rotating shaft 61.

Each of the return units 7 includes an engagement seat 71, a biasing unit 72, and a C-shaped retaining ring 73 received within one of the annular slot units 318 in the corresponding handle shaft 31 so as to retain the engagement seat 71 and the biasing unit 72 on the corresponding handle shaft 31. The biasing units 72 are configured as torsion springs. Each of the engagement seats 71 includes an outer ring 711, a ring-connecting wall 712 and an inner ring 713. Each of the ring-connecting walls 712 extends radially between the corresponding inner and outer rings 713, 711, and has radial inner and outer ends formed respectively and integrally with the corresponding inner and outer rings 713, 711 to define a retainer-engaging space 714 among the corresponding ring-connecting wall 712 and the corresponding inner and outer rings 713, 711. Each of the inner rings 713 defines a rectangular hole 715, and is sleeved fixedly on the bolt-rotating shaft 61 so as to allow for co-rotation of the corresponding engagement seat 71 and the spring bolt 62. Each of the outer rings 711 is disposed coaxially around the corresponding inner ring 713, and is formed with two stop stubs 716 extending radially and inwardly therefrom, and a second abutment plate 717 extending axially therefrom. Each of the retainer-engaging spaces 714 has a radial inner area 718 adjacent to the corresponding inner ring 713, and a radial outer area 719 adjacent to the corresponding outer ring 711. Each of the stop stubs 716 is disposed in the radial outer area 719 of the corresponding retainer-engaging space 714. The retaining portion 315 of each of the handle shafts 31 is inserted into the radial outer area 719 of the corresponding retainer-engaging space 714. The axial slots 317 in each of the handle shafts 31 engage respectively and fittingly the ring-connecting wall 712 and the stop stubs 716 in the radial outer area 719 of the corresponding retainer-engaging space 714. This allows for co-rotation of the corresponding handle shaft 31 and the corresponding engagement seat 71. Each of the biasing units 72 has two end legs 721 abutting respectively against the first and second abutment plates 215, 717 of a corresponding one of the inner and outer lock housings 21, 23 and the corresponding engagement seat 71. One of the biasing units 72 is disposed within the spring positioning ring 26 between the corresponding engagement seat 71 and the spring positioning ring 26, while one of the end legs 721 thereof abuts against both the first abutment plate 215 of the inner lock housing 21 and the horizontal plate 261.

Thus, the spring bolt unit 6 is biased by the biasing units 72 to rotate to a locking position shown in FIG. 3. As such, when either of the inside and outside handle units 3, 3′ is rotated on the lock housing unit 2, the retaining portion 315 of the corresponding handle shaft 31 rotates the corresponding engagement seat 71 and, thus, the spring bolt unit 6 away from the locking position. In this state, a door opening operation can be performed.

The electronic control mechanism 4 is disposed in the inner lock housing 21, and includes a motor 41 with an output shaft 411, a worm rod 42, an intermediate gear member 43 meshing with the worm rod 42, a contact switch 44 for controlling starting and stopping of the motor 41, an annular connecting seat 45 and a remote controller (not shown). Because the specific structure of the electronic control mechanism 4 is known in the art and is not pertinent to the claimed invention, a detailed description thereof will be omitted herein for the sake of brevity.

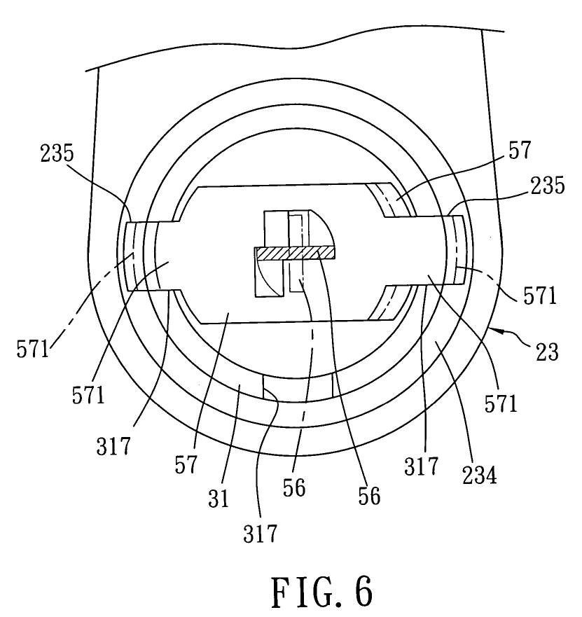

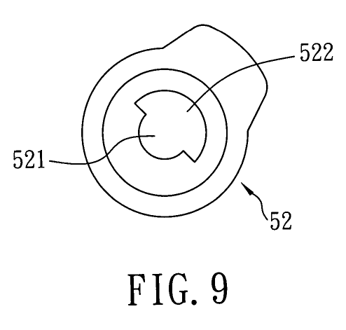

The manual control mechanism 5 includes a spindle 51, a connecting seat 52, a clutch seat 53, a clutch spring 54, a key-operated lockset 55, a connecting strip 56 and two locking plates 57. The spindle 51 is disposed coaxially within the handle shaft 31 of the inside handle unit 3. An end of the spindle 51 projects from the handle shaft 31 of the inside handle unit 3 to thereby allow for manual operation. An opposite end of the spindle 51 has a retaining unit, which is configured as an integral retaining portion 511 disposed rotatably within the radial inner area 718 of the retainer-engaging space 714 in the corresponding engagement seat 71 such that co-rotation of the spindle 51 and the corresponding engagement seat 71 is prevented. The connecting seat 52 is formed with a central hole 521 (see FIG. 9) that has an enlarged portion 522 engaging fittingly the retaining portion 511 of the spindle 51. This allows for co-rotation of the connecting seat 52 and the spindle 51. The clutch seat 53 is biased by the clutch spring 54 to engage the connecting seat 52. The key-operated lockset 55 is disposed within the handle shaft 31 of the outside handle unit 3′. The connecting strip 56 has two ends connected respectively and non-rotatably to the spindle 51 and a lock cylinder (not shown) of the key-operated lockset 55 in a known manner. The engagement seats 71 are sleeved non-rotatably on the connecting strip 56. The locking plates 57 are sleeved on the connecting strip 56 in a known manner. Each of the locking plates 57 has two integral retaining portions 571, and is movable between an unlocking position shown by the solid lines in FIG. 6 and a locking position shown by the phantom lines in FIG. 6. In the unlocking position, outer ends of the retaining positions 571 of the corresponding locking plate 57 are disposed respectively within two of the axial slots 317 in the handle shaft 31 of the outside handle unit 3′. In the locking position, the outer end of one of the retaining portions 571 of the corresponding locking plate 57 moves into the corresponding positioning notch 235 in the outer lock housing 23. Because the structures of the locking plates 57 are well known in the art, a further description thereof will be omitted herein for the sake of brevity.

Referring to FIGS. 2, 5 and 6, when it is desired to manually perform a door locking operation, a key (not shown) is inserted into the key-operated lockset 55, and is operated to rotate the connecting strip 56 in a locking direction. Alternatively, the spindle 51 is operated to rotate the connecting strip 56 from a horizontal position to a vertical position. Rotation of the connecting strip 56 results in movement of the locking plates 57 in opposite directions from the unlocking positions to the locking positions. This prevents rotation of the outside handle unit 3′ relative to the lock housing unit 2. In this state, however, rotation of the inside handle unit 3 is allowed.

Subsequently, when it is desired to manually perform a door unlocking operation, the key or the spindle 51 is operated to rotate the connecting strip 56 to the horizontal position. Hence, the retaining portions 571 of the locking plates 57 are all retracted into the handle shaft 31 of the outside handle unit 3′ so as to allow for rotation of the handle 32 of the outside handle unit 3′.

When it is desired to electrically perform a door locking or unlocking operation, the remote controller is operated to drive the motor 41 to thereby rotate the spindle 51, the connecting strip 56 and the lock cylinder of the key-operated lockset 55 in a known manner. Hence, the outside handle unit 3′ is locked on or unlocked from the lock housing unit 2.

Referring to FIGS. 2, 3, 4 and 5, when it is desired to open the door 10 in an unlocked state of the outside handle unit 3′, the handle 32 of either of the inside and outside handle units 3, 3′ is operated. For example, when the assembly of the handle 32 of the inside handle unit 3 and the corresponding handle shaft 31 is rotated, because the retaining portion 312 of the corresponding handle shaft 31 engages fittingly the radial outer area 719 of the retainer-engaging space 714 in the corresponding engagement seat 71, the corresponding engagement seat 71 co-rotates with the corresponding handle shaft 31. Thus, the spring bolt 62 is rotated and retracted into the door 10 due to the fact that the engagement seats 71 and the spring bolt 62 are sleeved fixedly on the bolt-rotating shaft 62. When the handle 32 is released, the biasing units 72 bias the spring bolt 62 to return to its locking position. During the door opening operation, because the retaining portion 511 of the spindle 51 is rotatable in the radial inner area 718 of the retainer-engaging space 714 in the corresponding engagement seat 71, the spindle 51 does not rotate.

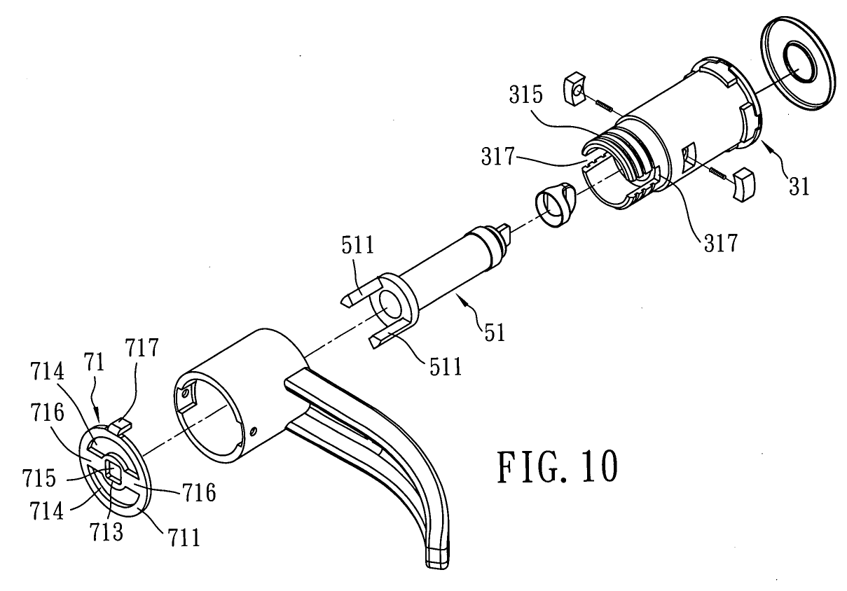

FIG. 10 shows a modified handle shaft 31, a modified spindle 51 and a modified engagement seat 71. The modified engagement seat 71 includes an inner ring 713, an outer ring 711 disposed coaxially around the inner ring 713, and two aligned ring-connecting walls 716 extending radially between the inner and outer rings 713, 711. Each of the ring-connecting walls 716 has radial inner and outer ends formed respectively and integrally with the inner and outer rings 713, 711 to define two retainer-engaging spaces 714 thereamong. The inner ring 713 and the ring-connecting walls 716 are disposed between the retainer-engaging spaces 714. The inner ring 713 defines a rectangular hole 715 therein. The modified spindle 51 has a retaining unit, which includes two integral retaining portions 511 movable respectively within the retainer-engaging spaces 714 in the engagement seat 71. As such, co-rotation of the modified spindle 51 and the modified engagement seat 71 is prevented. The modified handle shaft 31 has an integral retaining portion 315 that is formed with two open-ended axial slots 317 at an end thereof. The ring-connecting walls 716 of the modified engagement seat 71 engage respectively and fittingly the axial slots 317 in the modified handle shaft 31. This allows for co-rotation of the modified handle shaft 31 and the modified engagement seat 71.

With this invention thus explained, it is apparent that numerous modifications and variations can be made without departing from the scope and spirit of this invention. It is therefore intended that this invention be limited only as indicated by the appended claims.

I claim:

1. An electric lock adapted to be mounted to a door, said electric lock comprising:
a lock housing unit adapted to be disposed on the door;
inside and outside handle units each including a handle shaft that is journalled in said lock housing unit and that has a fixed retaining portion;
an electronic control mechanism disposed in said lock housing unit and operable so as to lock said outside handle unit on said lock housing unit and unlock said outside handle unit from said lock housing unit;
a manual control mechanism including a spindle journalled in said lock housing unit and coaxial with said handle shafts of said inside and outside handle units, said spindle having a fixed retaining unit and being rotatable so as to lock said outside handle unit on said lock housing unit and unlock said outside handle unit from said lock housing unit;
a spring bolt unit disposed rotatably in said lock housing unit; and
a return mechanism including two engagement seats connected to said spring bolt unit so as to co-rotate therewith, and a biasing unit for biasing said spring bolt unit to rotate to a locking position, said retaining unit of said spindle extending into one of said engagement seats, said retaining portions of said handle shafts extending respectively into said engagement seats, said retaining portions of said handle shafts of said inside and outside handle units rotating said engagement seats and, thus, said spring bolt unit away from said locking position so as to allow for a door opening operation when either of said inside and outside handle units is rotated on said lock housing unit.

2. The electric lock as claimed in claim 1, wherein each of said inside and outside handle units further includes a handle having a shaft portion sleeved rotatably on a corresponding one of said handle shafts, and a lever portion extending radially from said shaft portion, and two diametrically opposed direction-changing members interconnecting said handle and the corresponding one of said handle shafts and removable from one of said handle and the corresponding one of said handle shafts so as to allow for interchange of positions of said direction-changing members on said handle and, thus, reversal of an orientation of said lever portion of said handle.

3. The electric lock as claimed in claim 2, wherein said shaft portion of each of said handles of said inside and outside handle units has an inner surface that is formed with two grooves, each of said handle shafts having an annular outer surface that is formed with two grooves aligned respectively with said grooves in said shaft portion of the corresponding one of said handles, each of said direction-changing members including a bridging member disposed within said groove in the corresponding one of said handle shafts, and a spring also disposed within a corresponding one of said grooves in the corresponding one of said handle shafts and biasing a portion of said bridging member into a corresponding one of said grooves in said shaft portion of the corresponding one of said handles so as to result in engagement of said bridging member within both of the corresponding one of said grooves in the corresponding one of said handle shafts and the corresponding one of said grooves in said shaft portions of the corresponding one of said handles, thereby allowing for co-rotation of the corresponding one of said handle shafts and the corresponding one of said handles.

4. The electric lock as claimed in claim 3, wherein said shaft portion of each of said handles is further formed with two openings that are communicated respectively with said grooves in said inner surface of said shaft portion of a corresponding one of said handles, whereby, a tool can be inserted into either of said grooves in said handles through a corresponding one of said openings in said handles so as to push and retract a corresponding one of said bridging members into the corresponding one of said grooves in said handle shafts, thereby allowing for rotation of the corresponding one of said handles relative to the corresponding one of said handle shafts.

5. The electric lock as claimed in claim 1, wherein said spring bolt unit includes a bolt-rotating shaft journalled in said lock housing unit, and a spring bolt connected fixedly to said bolt-rotating shaft, each of said engagement seats of said return mechanism including an inner ring sleeved fixedly on said bolt-rotating shaft, an outer ring disposed coaxially around said inner ring, and a ring-connecting wall extending radially between said inner and outer rings and having radial inner and outer ends formed respectively and integrally with said inner and outer rings to define a retainer-engaging space among said ring-connecting wall and said inner and outer rings, said spindle of said manual control mechanism having an integral retaining portion that constitutes said retaining unit and that is movable within said retainer-engaging space in a corresponding one of said engagement seats such that co-rotation of said spindle and said engagement seats is prevented, said outer ring being formed with two stop stubs extending radially and inwardly therefrom, said retaining portion of said handle shaft of each of said inside and outside handle units being formed with three open-ended axial slots, which engage respectively and fittingly said ring-connecting wall and said stubs of a corresponding one of said engagement seats so as to allow for co-rotation of said bolt-rotating shaft and said handles.

6. The electric lock as claimed in claim 1, wherein said spring bolt unit includes a bolt-rotating shaft journalled in said lock housing unit, and a spring bolt connected fixedly to said bolt-rotating shaft, each of said engagement seats of said return mechanism including an inner ring sleeved fixedly on said bolt-rotating shaft, an outer ring disposed coaxially around said inner ring, and two aligned ring-connecting walls extending radially between said inner and outer rings, each of said ring-connecting walls having radial inner and outer ends formed respectively and integrally with said inner and outer rings to define two retainer-engaging spaces among said ring-connecting wall and said inner and outer rings, said inner ring and said ring-connecting walls being disposed between said retainer-engaging spaces, said spindle of said manual control mechanism including two integral retaining portions that constitute said retaining unit and that are movable respectively within said retainer-engaging spaces in a corresponding one of said engagement seats such that co-rotation of said spindle and said engagement seats is prevented, said retaining portion of said handle shaft of each of said inside and outside handle units having an end that is formed with two open-ended axial slots, which engage respectively and fittingly said ring-connecting walls of the corresponding one of said engagement seats so as to allow for co-rotation of said bolt-rotating shaft and said handles.
